(19) United States
(12) Patent Application Publication
(10) Pub. No.: US 2004/0046626 A1
(43) Pub. Date: Mar. 11, 2004

(54) Coil component and method of manufacturing the same

(76) Inventors: Toshiyuki Nakata, Mie (JP); Tsunetsugu Imanishi, Hyogo (JP); Hiroyuki Hamamoto, Hyogo (JP); Hidetoshi Hiwatashi, Osaka (JP); Tomokazu Kitagawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/451,777

(22) PCT Filed: Feb. 26, 2002
(86) PCT No.: PCT/JP02/01736

(30) Foreign Application Priority Data
Feb. 27, 2001 (JP) 2001-51803
Jan. 22, 2002 (JP) 2002-12515
Jan. 24, 2002 (JP) 2002-15051

(51) Int. Cl. H01F 27/02

(52) U.S. Cl. 336/83

(57) ABSTRACT

A coil component comprising; a coil 2 having a through-hole 1, a magnetic core including the coil, and a terminal 4, wherein magnetic core comprises a top portion 11 disposed at an upper part of the coil, a bottom portion 12 disposed at a lower part of the coil, and a middle portion 13. An outer layer thickness of the middle portion (W1) is less than a diameter of the through-hole, while the top portion and the bottom portion are higher in density than the middle portion. The configuration of the present invention provides a small size coil component with less occurrence of magnetic saturation to prevent lowering of inductance even with thin top portion 11 and bottom portion 12. The coil component further has improved reliability.

### TECHNICAL FIELD

The present invention relates to a coil component used in various electronic apparatuses, and a method of manufacturing the same.

### BACKGROUND ART

A conventional coil component will be described in the following with reference to the drawings.

FIG. 9 is a perspective view of a conventional coil component. FIG. 10 is a sectional view of the coil component. FIG. 11 is a sectional view of the coil component showing a part of the manufacturing process of the coil component.

In FIGS. 9-11, the conventional coil component comprises a coil 52 having a through-hole, an packaging 53 made up of magnetic material with the coil 52 disposed therein, and a terminal 54 connected to the coil 52. The packaging 53 is formed by molding magnetic powder 55 under pressure so as to cover the coil 52.

The packaging 53 is formed under a constant molding pressure over the entire part thereof, and also the packaging 53 is nearly uniform in density over the entire part thereof.

In the configuration of such conventional coil component, when intended to lower a height of the coil component, it is necessary to increase the molding pressure applied to the packaging 53 in order to entirely compress the packaging 53.

Though, the height of the packaging 53 can be lowered by compressing the packaging 53, the top and bottom portions of the packaging 53 are also reduced in thickness. Accordingly, there has been a problem that magnetic saturation is liable to occur, worsening the reliability, when the magnetic flux passing in the through-hole of the coil 52 passes through the top and bottom portions of the packaging 53.

In order to address the above problem, the present invention provides a coil component improved in reliability, in which magnetic saturation hardly occurs even when the top and bottom portions of the coil component are reduced in thickness for the purpose of lowering the height of the coil component.

### DISCLOSURE OF THE INVENTION

A packaging of the coil component of the present invention is a compressed powder magnetic core containing magnetic powder, comprising a top portion disposed at an upper part of the coil, a bottom portion disposed at a lower part of the coil, and a middle portion corresponding to the height of the coil. Also, the outer layer thickness (distance between the coil and the packaging surface) of the middle portion of the packaging including the coil is less than a diameter of the through-hole of the coil, and at the same time, a density the top portion and the bottom portion are higher than that of the middle portion.

By the above configuration, it is possible to eliminate the occurrence of magnetic saturation at the top portion and the bottom portion even when the top and bottom portions of the packaging are lowered in height by compressing until the outer layer thickness of the middle portion including the coil becomes less than the diameter of the through-hole of the coil. This is because the density of the top portion and the bottom portion are higher than that of the middle portion.

That is, a density of the inside of the through-hole of the coil, which corresponds to the middle portion of the packaging, is lower than densities of the top and bottom portions of the packaging. Accordingly, even when the magnetic flux passing through the through-hole passes through the top and bottom portions whose thickness is less than the diameter of the through-hole, magnetic saturation does not occur at the top and bottom portions, enabling the lowering of the height of the coil component. This is because the magnetic permeability can be increased in the top and bottom portions where the packaging density is higher than the middle portion.

### BRIEF DESCRIPTION OF THE DRAWINGS

FIG. 1 is a sectional view of a coil component in one preferred embodiment of the present invention.

FIG. 2 is a perspective view of the coil component.

FIGS. 3(a) to 3(e) respectively show a part of the manufacturing process for the coil component.

FIG. 4 is a perspective view of compressed powder for the coil component production.

FIG. 5 is a perspective view of a coil with terminals connected thereto.

FIG. 6 is a perspective view of the coil component before terminals are formed.

FIGS. 7(a) to 7(e) respectively show a part of a manufacturing process of another coil components of the present invention.

FIGS. 8(a) to 8(d) respectively show a part of a manufacturing process of yet another coil components of the present invention.

FIG. 9 is a perspective view of a conventional coil component.

FIG. 10 is a sectional view of the conventional coil component.

FIG. 11 is a sectional view showing a part of the manufacturing process of the conventional coil component.

### BEST MODE FOR CARRYING OUT THE INVENTION

First Embodiment

The present invention will be described in the following embodiment with reference to the drawings.

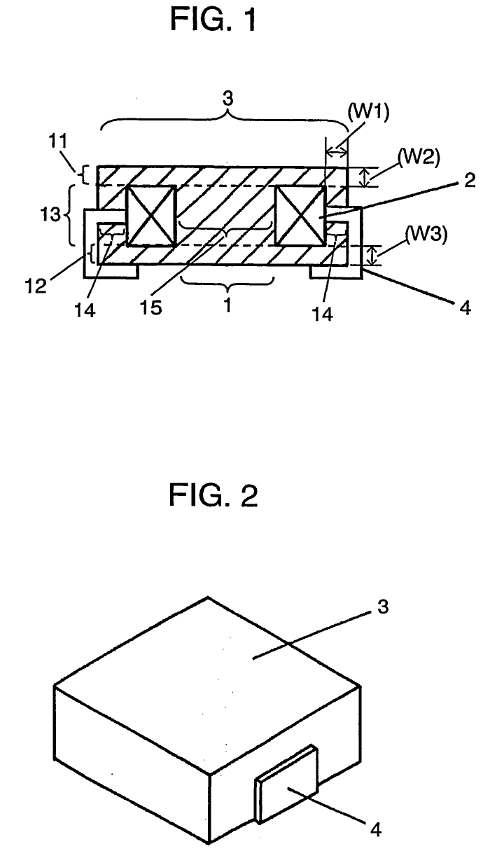

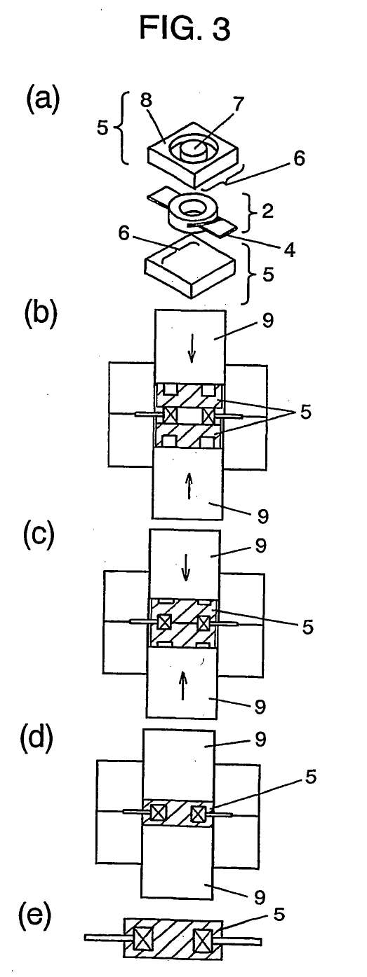

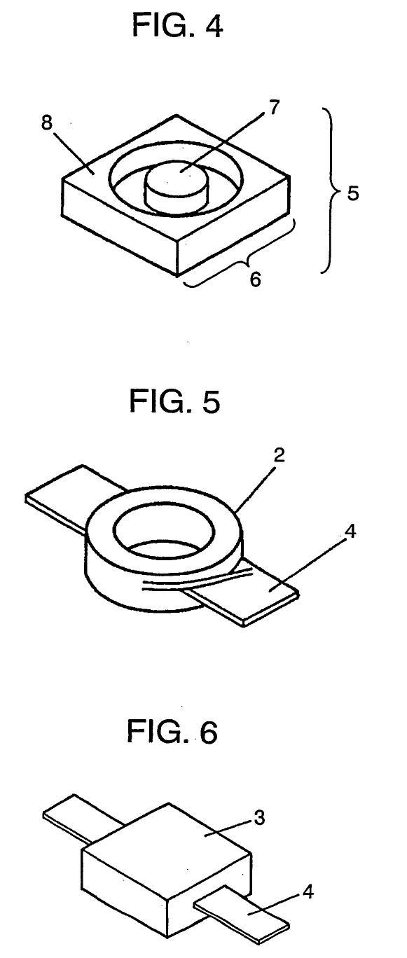

FIG. 1 is a sectional view of a coil component in one preferred embodiment of the present invention. FIG. 2 is a perspective view of the coil component. FIGS. 3(a) to 3(e) shows a part of the manufacturing process of the coil component. FIG. 4 is a perspective view of compressed powder for the coil component production. FIG. 5 is a perspective view of a coil with terminals connected thereto. FIG. 6 is a perspective view of the coil component before the terminals are formed.

In FIG. 1 through FIG. 6, a coil component in an embodiment of the present invention is 2 to 5 mm high and 10 mm square in shape, comprising a coil 2 having a through-hole 1, a packaging 3 including the coil 2, and terminals 4 connected to the coil 2.

Also, the packaging 3 is a compressed powder magnetic core (dust core) containing magnetic powder. The materials for the packaging 3 comprise thermosetting binder resin comprising silicone resin of tough resin component and elastic resin component and magnetic powder. The materials are mixed without heating so that the thermosetting resin does not cure and is molded under a pressure ranging from 0.5 to 2.0 t/cm², thereby forming compressed powder 5. Further, the compressed powder 5 is subjected to re-molding under a pressure ranging from 3.0 to 5.0 t/cm² so as to encapsulate the coil 2 while being heated at 100° C. to 180° C. so that the thermosetting resin completely cures, thereby molding packaging 3.

The compressed powder magnetic core (dust core) employs heattreated soft magnetic alloy powder as magnetic powder. The magnetic alloy powder ranges from 1 μm to 100 μm in average particle diameter, and it includes component A, chrome (Cr), oxygen (O), manganese (Mn), carbon (C) and iron (Fe). Component A includes at least one selected from the group consisting of silicon (Si), aluminum (Al), titanium (Ti) and magnesium (Mg). The composition of each component is as follows: 1 wt %≦component A≦7 wt %, 2 wt %≦Cr≦8 wt %, 0.05 wt %≦O≦0.6 wt %, 0.01 wt %≦Mn≦0.2 wt %, 0.005 wt %≦C≦0.2 wt %, and the rest is iron (Fe). Depending on the conditions where the coil components are used, it is possible to use nickel (Ni) of 2 wt %≦Ni≦15 wt % in place of component A.

Two pieces of compressed powder 5 are used for molding the packaging 3 as shown in FIG. 3(b). The compressed powder 5 is provided with a strong portion where the shape of compressed powder 5 is not collapsed by the pressure applied during re-molding operation and a weak portion where the shape of compressed powder 5 is collapsed due to the pressure applied during re-molding operation.

As shown in FIG. 4, the compressed powder 5 is a pot shape with an E-shaped cross section with back portion 6, a central portion 7 and an outside portion 8, and the back portion 6 serves as a strong portion, while the central portion 7 and the outside portion 8 respectively serve as a weak portion. The weak portion and the strong portion are formed by controlling the density of the compressed powder. That is, the density of compressed powder is lower at the weak portion, and higher at the strong portion. The strength of the weak portion is such that the shape is collapsed when a pressure of a few kg/cm² is applied.

Here, the expression that the shape of compressed powder 5 is “collapsed” means that the shape is collapsed to a size of particle size of the magnetic powder. At the strong portion having a strength high enough to keep the shape of compressed powder 5, a state of being broken into blocks (lumps) is not included in the range of being weak since the shape is not broken into the particle size of the magnetic powder.

And as shown in FIG. 3(a) to FIG. 3(d), in molding the packaging 3, the compressed powder is re-molded under pressure so that the top and bottom of coil 2 are held by the strong portions of two pieces of compressed powder 5 and that the outer periphery of coil 2 and the inner part of through-hole 1 are covered with the weak portion collapsed. Also, the compressed powder is heated during the re-molding under pressure so that the thermosetting resin completely cures.

In that case, the packaging 3 is molded so that an outer layer thickness (W1) shown in FIG.1 of the middle portion including the coil 2 is less than a diameter of the through-hole 1 of the coil 2. Also, as for the top portion 11 at the upper part of coil 2, the bottom portion 12 at the lower part of coil 2 and the middle portion 13 at the height part of coil 2, the top portion 11 and the bottom portion 12 are higher in density than the middle portion 13.

Particularly, the middle portion 13 is formed so that a density of the outside middle portion 14 is higher than a density of the inside middle portion 15.

As for these densities, the densities of the top portion 11 and bottom portion 12 are in a range from 5.0 to 6.0 g/cm³ and that of the inside middle portion 13 is 85% to 98% of the densities of the top portion 11 and bottom portion 12.

The manufacturing method of the present invention will be described in the following.

The manufacturing method of the prevent invention comprises an packaging molding process for encapsulating coil 2 in packaging 3 made up of magnetic material, and a terminal forming process for forming terminals 4 connected to the coil 2.

First, the packaging molding process comprises a step of molding two pieces of compressed powder 5 where a thermosetting resin binder, which include silicone resin having tough resin component and elastic resin component, and magnetic powder are mixed without heating so that the thermosetting resin does not cure, and are molded under pressure.

Compressed powder 5 has a pot shape with an E-shaped cross section with back portion 6, a central portion 7 and an outside portion 8, and the back portion 6 is a strong portion being able to keep the shape of compressed powder 5 during re-molding under pressure, while the central portion and the outside portion respectively serve as a weak portion being unable to keep the shape of compressed powder 5 during re-molding under pressure.

Next, the coil 2 is placed in the mold so that the top and bottom thereof are held by the strong portions of two pieces of compressed powder 5, then the two pieces of compressed powder 5 are re-molded under heat and pressure for molding the packaging 3. In this molding process, the outer periphery of coil 2 and the inside of through-hole 1 are covered with the weak portion.

In the re-molding, as shown in FIG. 3 (b), while the back portions 6 of two pieces of compressed powder 5 are holding the coil 2, two punches 9 press the central portion 7 and outside portion 8, which are the weak portions of compressed powder 5, thereby collapsing the weak portions of compressed powder 5 and covering the outer periphery of coil 2 and the inside of through-hole 1.

Particularly, due to the pressure applied during the re-molding operation, the back portion 6 (strong portion) of compressed powder 5 opposing to the inner part of through-hole 1 of coil 2 is buried into the through-hole 1 of coil 2 in a block. Also, while the back portion 6 (strong portion) of compressed powder 5 opposing to terminal 4 is buried toward the terminal 4 in a block, the central portion 7 (weak portion) and outside portion 8 (weak portion) of compressed powder 5 are collapsed, thereby covering the other outer periphery of coil 2 and the inner part of through-hole 1.

With the mold appropriately designed, in the packaging molding process, it is possible to make the outer layer thickness (W1) of the middle portion including the coil 2 less than the diameter of through-hole 1 of the coil 2. Also, according to the manufacturing method of the present invention, top portion 11 at the upper part of coil 2 and bottom portion 12 at the lower part of coil 2 are formed higher in density than the middle portion 13 corresponding to the height part of coil 2.

Further, as for the middle portion 13, there are provided inside middle portion 15 corresponding to the through-hole 1 of coil 2 and outside middle portion 14 corresponding to the outer periphery of coil 2, and the outside middle portion 14 is formed higher in density than the inside middle portion 15.

And the packaging 3 is molded so that the densities of the top portion 11 and bottom portion 12 is in a range from 5.0 to 6.0 g/cm³, while that of the inner middle portion 13 is 85% to 98% of the densities.

By the above configuration and method, even when the height of a coil component is lowered as a whole by making the outer layer thickness (W) of the middle portion including the coil 2 less than the diameter of through-hole 1 and by forming the top portion 11 and bottom portion 12, reducing the thickness thereof, it is possible to form the top portion 11 and the bottom portion 12 higher in density than the middle portion 13. As a result, it is possible to suppress the occurrence of magnetic saturation at the top portion 11 and the bottom portion 12.

That is, the top portion 11 and bottom portion 12 of the packaging 3 are higher in density than the inner part of middle portion 13, which corresponds to the inside of through-hole 1. Accordingly, even when the magnetic flux passing through the through-hole 1 passes through the top portion 11 and the bottom portion 12 whose thickness (W2, W3) is less than the diameter of through-hole 1, the top portion 11 and the bottom portion 12 can be possible to obtain higher magnetic permeability as the top portion 11 and the bottom portion 12 are higher in density than the middle portion 13. As a result, the height of the coil component can be lowered without allowing the occurrence of magnetic saturation at the top portion 11 and the bottom portion 12.

Also, the middle portion 13 includes inside middle portion 15 corresponding to through-hole 1 and outside middle portion 14 corresponding to the outside portion of coil 2. Since the outside middle portion 14. is higher in density than the inside middle portion 15, outside middle portion 14 is possible to obtain higher magnetic permeability. Accordingly, it is possible to reduce the size of the coil component in the lateral direction thereof and to save the space for mounting of the coil component without allowing the occurrence of magnetic saturation at the outside middle portion 14.

Particularly, the packaging 3 is molded so that the densities of the top portion 11 and bottom portion 12 are in a range from 5.0 to 6.0 g/cm³ and that of the inner middle portion 13 is 85% to 98% of the densities, and therefore, excessive stresses will not be applied to the coil 2. At the same time, it is possible to suppress the breakdown of packaging 3 itself due to internal stresses or the like while suppressing the breakdown of coil 2. Also, it is possible to suppress the occurrence of magnetic saturation and to make the coil component smaller in size.

The packaging 3 is a compressed powder magnetic core, and has a specific composition. That is, the ratio of Fe component is high and it is advantageous for DC-Bias characteristics. Moreover, containing Cr component suppresses the generation of rust due to Fe component. Further, since the content of Cr is not more than 8 wt %, it is possible to suppress a loss in a frequency range of higher than 100 kHz. In this way, the present invention is able to realize composite magnetic material having excellent corrosion resistance without losing the magnetic characteristic.

Also, an ordinary powder molding is generally uses powder for the molding, but in the present invention where solid compressed powder 5 is used, the quantity of compressed powder 5 between the punch 9 and the coil 2 hardly varies during re-molding under pressure, and the covering thickness of packaging 3 is easier to make uniform over the entire periphery of coil 2. Accordingly, it is possible to suppress the dispersions in characteristics such as inductance, saturation characteristic and magnetic losses during DC-biasing of the inductance. Further, since the coil 2 can be held by compressed powder 5, the coil 2 is precisely positioned, and defective molding of packaging 3 may be prevented. Regarding. the compressed powder 5, magnetic powder and binder including thermosetting resin are mixed and pressed to form compressed powder 5. And, the thermosetting resin includes silicone resin having tough resin component and elastic resin component, therefore it is possible to mold the packaging well balanced in strength and brittleness, and to minimize the defect of packaging 3.

Further, since coil 2 is covered when compressed powder 5 is re-molded under pressure, the coil 2 can be precisely covered. Also, as gaps between compressed powder 5 and coil 2 can be completely filled, it is possible to improve the magnetic efficiency by reducing the magnetic gaps.

Particularly, as the strong portion of compressed powder 5 reliably holds one side of coil 2, the position of coil 2 is hardly misregistrated during re-molding under pressure, and another side of coil 2 can be easily covered with the weak portion of compressed powder 5 as the weak portion collapses. Accordingly, it is possible to make the covering of packaging 3 uniform in thickness over the entire periphery of coil 2 and to suppress the dispersions in characteristics of the coil component.

Also, the compressed powder 5 is a pot shape with an E-shaped cross section with back portion 6, a central portion 7 and an outside portion 8, and the back portion 6 is a strong portion, while the central portion 7 and the outside portion 8 respectively serve as a weak portion. As a result, positional misregistration hardly occur due to the strong portion of compressed powder 5, and it is easier to cover the other side of coil 2, and the dispersions in characteristics of the coil component can be reduced.

As described above, according to the embodiment of the present invention, the covering of packaging 3 is easier to become uniform in thickness over the entire periphery of coil 2, and it is possible to reduce the dispersions in characteristics and also to obtain higher magnetic permeability in top portion 11 and bottom portion 12 as the top portion 11 and bottom portion 12 of packaging 3 are higher in density than the middle portion 13. Also, the height can be lowered without allowing the occurrence of magnetic saturation at the top portion 11 and the bottom portion 12.

In the embodiment of the present invention, the compressed powder 5 has E-shaped cross section, but it is also possible to make the central portion 7 longer or shorter than the outside portion 8 provided that the shape is within the scope of the present invention. Particularly, a T-shaped cross section with only the central portion 7 formed at the back portion 6 and a C-shaped cross section with only the outside portion 8 formed at the portion can be considered equivalent to the E-shaped cross section of the present embodiment.

Also, as for the relative positions of coil 2 and compressed powder 5, one side of the coil 2 may be held by a strong portion of one compressed powder 5, while another side of the coil 2 is supported by a weak portion of another compressed powder 5. In that case, it is also allowable to make the strong portion of E-shaped compressed powder 5 higher in density than the weak portion.

Further, as for the coil 2, it is allowable to wind a flat wire as well as a round wire into an edgewise coil. In this case, it is possible to enhance the space factor of the coil and to make it compatible with high current. Especially, when a flat wire is tightly wound so that packaging 3 will not be molded between the adjacent flat wires, it is possible to suppress the generation of magnetic flux that circulates around the flat wire and to reduce the losses since the packaging 3 is not molded between the flat wires.

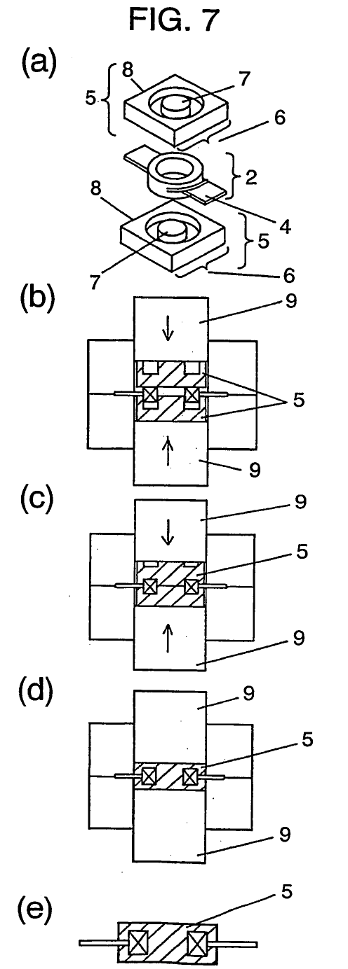

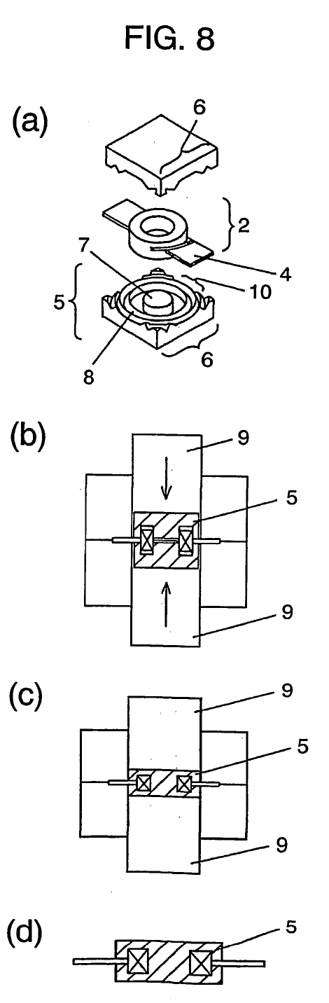

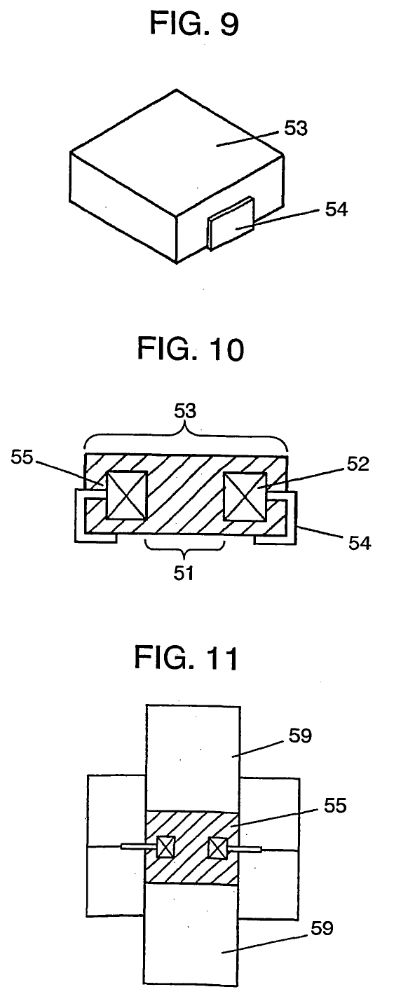

As the other examples of molding, as shown in FIG. 7 and FIG. 8, one of the compressed powder 5 can be re-molded under pressure so that one side of the coil 2 is held by the back portion 6 of the strong portion, and another compressed powder 5 is placed so that the central portion 7 is inserted into the through-hole 1 of coil 2. Also, as shown in FIG. 8, re-molding can be performed using two compressed powders 5 having small peaks and valleys 10 at tip end portions of central portion 7 or the outside portion 8 and opposed to each other. Further, it is also possible to perform re-molding, providing one or more dividing grooves at the back portion 6 of compressed powder 5. By using various arrangements of the compressed powder 5 as described above, it becomes possible to cover the coil 2 further easier and to minimize the dispersions in characteristics of the coil component.

In the present embodiment of the present invention, before or during re-molding under pressure, one side of the coil 2 is supported by the strong portion of compressed powder 5, but it is preferable to let one side of the coil 2 be supported by the strong portion of the compressed powder even after re-molding under pressure.

### Industrial Applicability

According to the present invention as described above, even when the height of a coil component is lowered as a whole by forming the top portion of the packaging, corresponding to the upper part of the coil, and the bottom portion of the packaging, corresponding to the lower part of the coil, less in thickness until the outer layer thickness of the middle portion including the coil becomes less than the diameter of the through-hole of the coil, it is possible to suppress the occurrence of magnetic saturation at the top and bottom portions since the top portion and the bottom portion are higher in density than the middle portion.

That is, the density of the inside of the through-hole of the coil, which corresponds to the middle portion of the packaging, is lower than the density of the top portion and bottom portion of the packaging. Accordingly, the magnetic permeability can be increased at the top portion and bottom portion as the top portion and bottom portion are higher in density than the middle portion. Thus, it is possible to provide a coil component and its manufacturing method by which the height can be lowered without allowing the occurrence of magnetic saturation at the top and bottom portions even when the magnetic flux passing through the through-hole of the coil passes through the top portion and the bottom portion whose thickness is less than the diameter of the through-hole.

1. A coil component comprising:
a coil having a through-hole;
a magnetic core including said coil; and
a terminal connected to said coil, wherein
said magnetic core includes a top portion disposed at an upper part of said coil, a bottom portion disposed at a lower part of said coil, and a middle portion disposed at the height of said coil, an outer layer thickness of said middle portion is less than a diameter of said through-hole, while said top portion and said bottom portion are higher in density than said middle portion.

2. The coil component of claim 1, wherein said middle portion comprises an inside middle portion positioned in the through-hole and an outside middle portion surrounding an outer part of said coil, said outside middle portion being higher in density than said inside middle portion.

3. The coil component of claim 1, wherein said magnetic core is formed so that a densities of said top portion and said bottom portion are in a range from 5.0 to 6.0 g/cm³ and a density of said inside middle portion is 85% to 98% of the densities of said top portion and said bottom portion.

4. The coil component of claim 1, wherein said coil is an edgewise coil formed by winding a flat wire in such manner that adjacent flat wires are in tight contact with each other.

5. The coil component of claim 1, wherein said magnetic core comprises a binder including thermosetting resin and magnetic powder.

6. The coil component of claim 5, wherein said thermosetting resin is a silicone resin including tough resin component and elastic resin component.

7. The coil component of claim 5, wherein a compressed powder used as a material for manufacturing said magnetic core has a weak portion being unable to keep a shape of said compressed powder and a strong portion being able to keep the shape of said compressed powder, when said compressed powder is re-molded.

8. The coil component of claim 7, wherein a cross section of said compressed powder has E-shape with a back portion, central portion and outside portion.

9. The coil component of claim 8, wherein the back portion of said compressed powder is the strong portion, while the central portion and the outside portion serve as the weak portion.

10. The coil component of claim 7, wherein tip end of the central portion or outside portion of said compressed powder has small peaks and valleys.

11. The coil component of claim 7, wherein at least one dividing groove is provided at the back portion of said compressed powder.

12. A method of manufacturing coil component comprising the steps of:
encapsulating a coil having a through-hole with a magnetic core including magnetic powder; and
forming a terminal connected to said coil, wherein
said encapsulating is processed such that an outer layer thickness of a middle portion including said coil is made less than a diameter of said through-hole, and a top portion of said magnetic core disposed at an upper part of said coil and a bottom portion of said magnetic core disposed at a lower part of said coil are made higher in density than said middle portion.

13. The method of claim 12, wherein said middle portion comprises an inside middle portion disposed in said through-hole and an outside middle portion disposed at an outer periphery of said coil, and a density of said outside middle portion is higher than a density of said inside middle portion.

14. The method of claim 12, wherein densities of said top portion and said bottom portion are in a range from 5.0 to 6.0 g/cm³ and the density of said inside middle portion is from 85% to 98% of the densities of said top portion and said bottom portion.

15. The method of claim 12, wherein said encapsulating process further comprises the steps of:
forming compressed powder with binder including thermosetting resin and magnetic powder; and
forming an encapsulating magnetic core by re-molding said compressed powder under pressure so as to cover said coil.

16. The method of claim 15, wherein said compressed powder is formed through mixing and molding without heating so as not to cure said thermosetting resin, and is re-molded under heat and pressure so that said thermosetting resin cures.

17. The method of claim 15, wherein said forming of compressed powder includes forming of a weak portion and a strong portion, said weak portion being unable to keep a shape of said compressed powder during said re-molding and said strong portion being able to keep a shape of said compressed powder during said re-molding.

18. The method of claim 15, wherein said thermosetting resin comprises silicone resin including tough resin component and elastic resin component.

19. The method of claim 17, wherein said encapsulating magnetic core forming process is executed in such manner that one side of the coil is supported by the strong portion of said compressed powder while the other side of said coil is covered with said weak portion.

20. The method of claim 17, wherein the cross section of said compressed powder has E-shape with a back portion, central portion and outside portion, said back portion being said strong portion, while said central portion and said outside portion being said weak portion.

21. The method of claim 15, wherein tip end of the central portion or outside portion of said compressed powder has small peaks and valleys.

22. The method of claim 15, wherein at least one dividing groove is provided at the back portion of said compressed powder.
